(19) United States
(12) Patent Application Publication
(10) Pub. No.: US 2003/0115558 A1
(43) Pub. Date: Jun. 19, 2003

(54) Optimisation of electronic system parameters

(76) Inventor: Christopher David Hilton, Wokingham (GB)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/295,564

(22) Filed: Nov. 15, 2002

(30) Foreign Application Priority Data
Nov. 15, 2001 (GB) 0127429.9

(51) Int. Cl. G06F 17/50

(52) U.S. Cl. 716/4

(57) ABSTRACT

Owing to the complexity of integrated circuits, circuit parameters such as component values must be determined to achieve an optimised measure of circuit performance. A method of determining a preferred value of at least one electronic system component, 12, 14, 16, 18, 20, 22, 24, 26 or 28, which optimises one or more characteristics of an electronic system 10. The method comprising: expressing a steady state condition; selecting a trial value for the or each system component and calculating said steady state at the or each point; and applying a perturbation to the value of at least one of the said system components, such that a localised region around said steady state condition is linearised; and determining, as a consequence of said perturbation, a new steady state condition of said electronic system. A computer program carries out the prescribed optimisation method.

### BACKGROUND OF THE INVENTION

This invention relates to the field of optimisation of electronic system parameters.

Over the years, electronic systems, particularly integrated circuits, have become increasingly complex. It is desirable to determine circuit parameters, such as component values, in order to achieve an optimised measure of circuit performance (e.g. voltage gain). Typically, this optimisation is also subject to other constraints, such as a maximum permissible noise ceiling.

There are two aspects to optimising a circuit. Firstly, a method of evaluating circuit performance for a given set of devices, such as an equation type method, is required. Secondly, an optimisation algorithm is required. Many optimisation algorithms exist, and the most efficient of these are gradient-based algorithms that require the calculation of the derivatives of the circuit performance and the constraints with respect to the circuit parameters, using given values of the components as well as chosen values of the circuit performance and constraints.

The first step in obtaining the value of circuit performance is typically the determination of the DC operating point at each node of the circuit. The DC operating point at each node must therefore be calculated for a given set of component values. The new DC operating point at each node must then be calculated for a very small change in component values. This is to enable the derivative of the DC operating point with respect to the component values to be calculated using finite differencing. However any residual inaccuracy in the calculation of the new DC operating point will adversely affect the accuracy of such gradient calculations and therefore the convergence properties of the optimisation solution.

This means that the new DC operating point has to be calculated very accurately, which in turn means that it can take a very long time for a computer to arrive at the optimised values. Additionally, a large amount of processing power is required to resolve the optimisation problem. “Sizing of Cell-Level Analog Circuits using Constrained Optimization Techniques” (IEEE Journal of Solid State Circuits, Vol. 28, No. 3, March 1993, pp 233-241) describes a different method of circuit optimisation. Here, the unknown voltages at each node of the circuit to be optimised are represented as extra design variables. Extra constraints are added to represent the laws governing conservation of current. The method described in the above-referenced document, which uses an “infeasible path” optimisation algorithm, results in intermediate designs that may be unphysical as they do not conserve current. Due to the unphysical properties of intermediate designs, the algorithm may be trapped by local minima, and could therefore produce spurious results.

It is an object of the present invention to provide an improved circuit optimisation method.

### SUMMARY OF THE INVENTION

According to a first aspect of the present invention there is provided a method of determining a preferred value of at least one electronic system component which optimizes one or more characteristics, of an electronic system, the method comprising the steps of: expressing a steady state condition of the system, at at least one point on the system, in terms of at least one of said system components; selecting a trial value for the or each system component and calculating said steady state at the or each point; and applying a perturbation to the value of at least one of the said system components of the system, such that a localised region around said steady state condition is linearised; and determining, as a consequence of said perturbation, a new steady state condition of said electronic system.

This is advantageous over the prior art because, as the trial value of the components and the steady state condition is known, the linearisation of the region around the steady state condition allows the new steady state condition associated with the change in component value to be calculated analytically. This therefore allows the derivative of the steady state condition to be calculated to any degree of accuracy, very quickly. The linearisation may be implemented using, for example, a first order Taylor expansion.

With the prior art however the steady state condition has to be calculated numerically, using complex convergence algorithms. Additionally, the steady state condition has to be calculated very accurately to ensure that the partial derivative of the steady state condition with respect to each of the components was accurate. This means that there are more iterations needed and so accordingly more time and processing power is required.

Preferably, the method of optimising will be a computer program although other forms of implementing the method, such as, in microprocessor hardware are possible.

Also, preferably, the linearisation is performed by a first order Taylor Expansion although other mathematical expansions can be used.

### BRIEF DESCRIPTION OF THE DRAWING

An embodiment of the present invention will now be described, by way of example only, with reference to the following drawing in which:

FIG. 1 shows a part of a CMOS (Complementary Metal Oxide Semiconductor) Low Noise Amplifier whose component values are to be optimised in accordance with the principles of the present invention.

### DETAILED DESCRIPTION OF THE PREFERRED EMBODIMENT

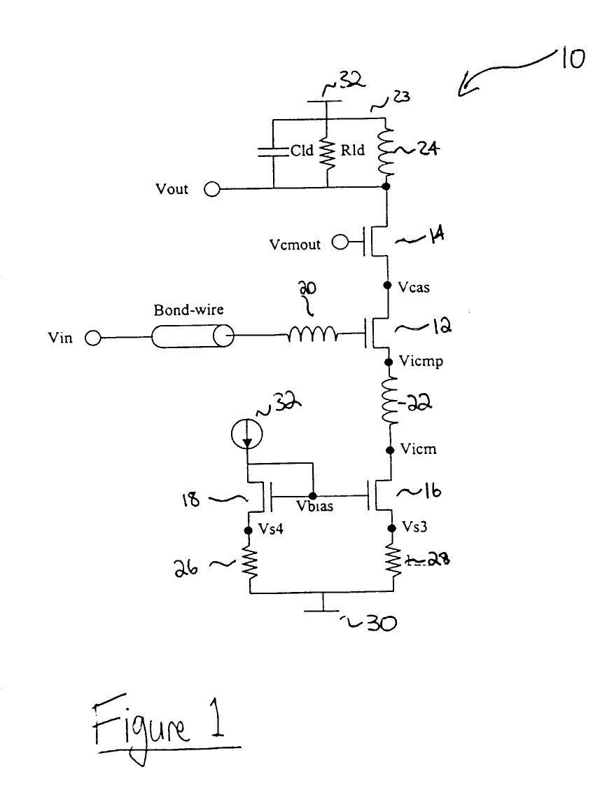

FIG. 1 shows a part of a CMOS (Complementary Metal Oxide Semiconductor) low noise amplifier (LNA) 10. The arrangement of the components in the LNA 10 is known as such and a detailed description of the purpose of each component will not therefore be described.

The values of several of the components of the LNA 10 need to be determined to enable the LNA 10 to operate in accordance with a predefined criterion, such as the maximization of voltage gain. As may be seen in the exemplary circuit of FIG. 1, the values of first, second, third and fourth n-channel transistors 12, 14, 16, 18, first, second and third spiral inductors 20, 22, 24 and first and second resistors 26 and 28 all need to be determined for optimal circuit performance.

To carry out a circuit analysis, various voltages need to be defined at different locations around the circuit defining the LNA 10. An input voltage to be amplified by LNA 10 is fed in, via a bond wire, to the first inductor 20. The output of the first inductor 20 is fed into the gate of the first transistor 12. A voltage VCAS is generated at the drain of the first transistor 12 and a voltage V_{icmp} is generated at the source of the first transistor 12. The second inductor 22 is connected to the source of the first transistor 12. The output of the second inductor 22 is connected to the drain of the third transistor 16. A voltage V_{icm} is also generated at the drain of the third transistor 16. The source of the third transistor 16 is connected to the second resistor 28. A voltage Vₛ₃ is generated at the source of the third transistor 16. The output of the second resistor 28 is connected to a first voltage source 30.

The gate of the third transistor 16 is connected to the drain and gate of the fourth transistor 18. Also connected to the drain of the fourth transistor 18 is a current source 32. The current source 32 is arranged to bias the fourth transistor 18. The value of the current supplied by the current source 32 needs to be determined to enable the LNA 10 to operate in accordance with the predefined criterion. A voltage V_{bias} is generated at the gate of the fourth transistor 18. The first resistor 26 is connected to the source of the fourth transistor 18. The output of the first resistor 26 is connected to the first voltage source 30. A voltage Vₛ₄ is generated at the source of the fourth transistor 18.

The source of the second transistor 14 is connected to the drain of the first transistor 12. The voltage V_{cas} is also generated at the source of the second transistor 14. A voltage V_{cmout} is input to the gate of the second transistor 14.

The voltage V_{cmout} switches the second transistor 14 on by a suitable amount such that the conduction between the drain and the source of the second transistor 14 is controlled, therefore influencing the mode of operation of the first and second transistor 12 and 14. This means that the voltage V_{cmout} needs to be determined in accordance with the predefined criterion. The drain of the second transistor 14 is connected to a parallel network 23. The parallel network 23 is also connected to a second voltage source 32. The parallel network 23 generates the output voltage Vₒᵤₜ and tunes the LNA 10 to a resonant frequency. The parallel network 32 consists of a third spiral inductor 24, a resistor and capacitor all connected in parallel.

In this example, the unknown component values are to be calculated to optimise a given circuit characteristic. More specifically, the performance of the LNA 10 can be characterised by, for example, the resonant frequency of the LNA 10 and the voltage gain at that frequency. Other parameters may include the noise figure of the LNA 10, the quiescent power consumption or the like. For the sake of clarity, only the voltage gain of the LNA 10 will be optimised in the following example although it is understood that further performance characteristics may be optimised instead of the voltage gain.

The value of each of the first, second, third and fourth transistors 12, 14, 16, 18 can be described in terms of the width and length of the respective transistor. The width and length of each transistor therefore needs to be calculated.

The value of each of the first, second and third spiral inductors 20, 22, 24 can likewise be described by the number of turns of the inductor, the width of the turns and the outer diameter of the inductor. These characteristics need to be calculated to give the LNA 10 the required performance. The first and second resistors 26 and 28 are described by the resistance of the resistor.

In addition to a determination of those dimensions of the transistor, inductor and resistor which provide the maximum voltage gain, (such that the circuit is optimised according to the chosen criterion which is maximisation of voltage in this example) it is also necessary, in this case, to determine V_{cmout} and the magnitude of the current source 32. This means that, for the circuit of FIG. 1, there are 21 parameters to be determined.

During the analysis of a circuit for optimisation purposes, it is appropriate to attempt to reduce the total number of independent variables. In the present case, it may be seen that the third and fourth transistors 16 and 18 and the first and second resistors 26 and 28 are arranged as a current mirror. This means that the values of the voltages Vₛ₃ and Vₛ₄ must be equal, and therefore the value of the second resistor 28 is fixed for a given value of the first resistor 26. Additionally, the width of the third transistor 26 is chosen to be a fixed multiple width of the fourth transistor 28. In this case, the third transistor 26 is selected to be 16 times wider than the fourth transistor 28. The length of the third and fourth transistor 26 and 28 are chosen to be equal.

By linking these parameters together the number of variables in the circuit is reduced to 18, and each must be calculated to optimise, in this case, the voltage gain of the LNA 10. Even then, other specific characteristics need to be within defined limits. For example, the LNA 10 may need a specified maximum power consumption (Pmax) or a specified maximum noise figure (nfmax). Additionally, the component values may be limited so that any particular component, for example the first, second and third spiral inductor 20, 22, 24 respectively is constrained to a maximum value. The width of the first transistor 12 may also be limited to a predefined maximum or minimum because of constraints on the technology used to fabricate the components, for example, the length may be limited to at least 0.18 μm and a width of at least 2 μm.

It will of course be understood that, in a real situation, a number of other measures of circuit performance will need to be considered and maintained within predetermined constraints, such as input impedance match, specified resonant frequency, area on silicon (for I.C.s) etc. Also it is envisaged that one particular constraint may be that the components enable the performance of the circuit to be maintained under varying external conditions, such as temperature, and under different manufacturing tolerances. However, the following example constrains just two parameters (Pmax and nfmax) whilst optimising the voltage gain. This is for the sake of clarity of explanation and it is to be understood that the invention is not so limited.

Mathematically, the above set of criteria can be expressed as:

find x which:

maximises f₀(x)

subject to fⱼ(x)≦0 for j=1,2

where the vector x contains the values of the component values to be determined. Here:

f₀(x)≡V_{gain}(x)(V_{gain} is voltage gain of the LNA 10)

f₁(x)≡nf(x)−(nfmax)

f₂(x)≡P(x)−(Pmax).

As can be seen from these mathematical expressions, ensuring that f₁(x) is ≦0 means that the noise figure of the circuit when the component values have been determined will be below the maximum permitted. Additionally, ensuring f₂(x)≦0 means that the power consumption of the circuit when the component values have been determined will be below the specified maximum power consumption.

For optimisation to occur, the circuit parameters f₀, f₁, and f₂ need to be calculated for a given set of component values. This means that a starting point for determining the optimised components values needs to be defined. These starting values are typically taken from a previous design with a similar specification. However, the starting values may equally be chosen by the designer and need not necessarily satisfy the constraints as explained below.

There are several known methods for solving mathematical optimisation problems. One method uses an iterative algorithm and is known as Sequential Quadratic Programming. This algorithm is an infeasible path algorithm, which means that at any iteration up to the final solution, constraints can be violated. This means that intermediate designs can be very unusual, for example, the design variables may be physically unrealistic or even impossible.

The Lagrangian function associated with the optimisation problem is approximated to a quadratic function in x and each of the functions f₁(x) and f₂(x) are linearly approximated. The algorithm solves the constrained optimisation problem by solving a sequence of quadratic subproblems. At every major iteration, the algorithm formulates a quadratic programming subproblem from the function f₀(x), and the set of f₁(x) and f₂(x) at the current point. The subproblem is solved iteratively. The solution to the subproblem is then used as the next major iteration. The iterations continue until certain convergent criteria, for example, a predetermined minimum accuracy of x, are met. Also, the iterations may cease when the improvement of a particular circuit characteristic is below a threshold for a given change in component value.

At each major iteration, the first and second derivatives of each of the functions f₁(x) and f₂(x) with respect to each of the component values is required. In practice, however, the second derivative is calculated from information obtained from the first derivatives at each successive iteration. Clearly, the derivatives need to be calculated accurately to enable the optimised component values to converge to an accurate value. If the derivatives are not accurately chosen, the optimised component values may not converge at all.

To calculate the values of f₁(x) and f₂(x), models of the components need to be used. The model used in this example calculates the current entering a node to which each component is attached, for given voltages present on that node. For example, with reference to FIG. 1, the node that has the voltage Vₛ₃ present will receive current contributions from the second resistor 28 and the drain of the third transistor 16. It is apparent that a fixed voltage may appear at a node (e.g. a ground or supply voltage). As the voltages at the nodes describe the circuit at any given time, it would be appreciated by the skilled person that the current flowing at each node can similarly be used to describe the circuit at any given time. The model used for each transistor in the present example is BSIM3 version 3 developed by Berkeley University, USA. This model is complex and non-linear. For inductors, a standard model is used and resistors and capacitors are modelled as pure resistance and capacitance respectively.

However, as the optimisation algorithm is an infeasible path algorithm, the design values can take negative values. Since in reality transistor widths and lengths, for example, cannot be negative values, these are not used directly as design variables. Instead, a mapping from design variables to device sizes is used which renders the device sizes positive for all values of the design variables.

For a chosen set of values of the component values x, the DC operating point needs to be ascertained and a small signal analysis of the LNA 10 needs to be conducted. The DC operating point of the LNA 10 is the steady state condition of the circuit in the presence of fixed bias voltages only. Small signal analysis is the reaction of the circuit to an infinitesimal transient signal on top of the (quiescent) DC operating point. In this example, the unknown voltages that need to be calculated are V_{bias}, Vₛ₃, Vₛ₄, V_{icm}, V_{icmp}, V_{cas} and Vₒᵤₜ. To determine the unknown voltages, it is necessary to model the current produced by a component at a node when a voltage is present at that node. This is firstly done for steady state conditions.

Under steady state conditions, the capacitors are considered as open circuits, the inductors are modelled as resistances, so, in relation to Lₛ, L_{d} and L_{g}, the corresponding resistances are rₛ, r_{d} and r_{g}. The transistors are modelled as a non linear function I_{ds} whose value is dependent upon V_{gs}, V_{ds}, V_{bs} and the width and length for the transistor. I_{ds} describes the current flow into the drain for given gate source, drain source and bulk source voltages.

In this case, the DC operating point of the unknown voltages can be calculated using current conservation at each node (Kirchoff's Law). As previously noted, the voltage of Vₛ₃ is equal to the voltage at V₄. Therefore it is apparent that the six unknown voltages can be calculated using six simultaneous equations. These six equations can be decomposed: the values of V_{bias} and Vₛ₄ are determined by solving two simultaneous equations that express the fact that the current generated by the current source 32 (I_{bias}) flows through the fourth transistor 18 and the first resistor 26. These two equations are:

g₁(V_{bias}, Vₛ₄)≡I_{bias}−I_{ds18}(V_{bias}−Vₛ₄,V_{bias}−Vₛ₄ ,−Vₛ₄)=0 (1)

g₂(V_{bias},Vₛ₄)≡I_{bias}−(Vₛ₄−Vₛₛ)/R1=0 (2)

where Vₛₛ is the voltage produced by the first voltage source 30 and R1 is the resistance of the first resistor 26 and I_{dsn} is the current flowing into the drain of transistor n, as a function of V_{gs}, V_{ds} and V_{bs} at zero frequency, according to the BSim3 Model.

Also the values of V_{icm}, V_{icmp}, V_{cas} and Vₒᵤₜ are determined by solving a set of four simultaneous equations that express the fact that half of the current that flows through the third transistor 16 flows through the second inductor 22, the first and second transistor 12 and 14 and the parallel network 23. It should be noted that only half of the LNA 10 is shown in FIG. 1 and the network above the third transistor 16 is mirrored, in reality. In other words, the network above the third transistor 16 is one half of a differential structure. These four equations are:

h₁(V_{icm},V_{icmp},V_{cas},Vₒᵤₜ)≡I_{ds16}(V_{bias}−Vₛ₃,V_{icm}−Vₛ₃,−Vₛ₃)/2−(Vᵢₘₚ−V_{icm})/rs=0 (3)

h₂(V_{icm},V_{icmp},V_{cas},Vₒᵤₜ)≡(V_{icmp}−V_{icm})/rs−I_{ds12}(Vᵢₙ₋V_{icmp}, V_{cas}−V_{icmp}V_{icmp})=0 (4)

h₃(V_{icm},V_{icmp},V_{cas},Vₒᵤₜ)≡(V_{icmp}−V_{icm})/rs−I_{ds14}(V_{cmout}−V_{cas},Vₒᵤₜ−V_{cas}−V_{cas})=0 (5)

h₄(V_{icm},V_{icmp},V_{cas},Vₒᵤₜ)≡(V_{icmp}−V_{icm})/rs−(AV_{dd}−Vₒᵤₜ) (1/R_{ld}+1/rd)=0 (6)

Due to the complexity of the functions in the simultaneous equations, it is not possible to solve them analytically. An iterative type method that converges on a desired solution is therefore employed to yield values for the unknown voltages. A typical iterative method used is a Newton-Raphson method although iterative methods such as a Levenberg-Marquardt method can be used. The solutions to these simultaneous equations will yield a DC operating point for V_{bias}, Vₛ₄, V_{icm}, V_{icmp}, V_{cas} and Vₒᵤₜ. Typically, the DC operating point is calculated to an accuracy of lnV, although other accuracies may be acceptable depending on the precision required for the values of performance characteristics.

As was noted earlier, to iteratively solve a set non linear functions with more than one variable, a Newton-Raphson type method is employed. For instance, the problem can be transformed to an unconstrained least squares minimisation problem in several variables by minimising the sum of the squares of the functions. The gradient of the function is then taken at a point with respect to each of the variables. The next iteration is then taken in the relation to the variable with the steepest gradient. This is well known in the art.

Once the DC operating point has been calculated for each of the nodes in the circuit for a given set of circuit component parameters, small signal analysis needs to be performed on the circuit. Small signal analysis allows the performance of the circuit to be measured for a given perturbation applied to the large scale signal which is, in this case, the DC operating point. Small signal analysis is known in the art and many techniques, such as nodal analysis, for deriving the small signal performance of the circuit are known.

To perform small signal analysis, typically, the current flowing into each circuit node is described by a linear function of the voltage on each node. As will be appreciated, the linear relationship between voltage and current for each device is dependent upon the DC operating point. In a similar fashion to the process described above with relation to the DC operating point, a set of simultaneous equations is derived at each node by applying the current conservation laws. However, as the simultaneous equations for small signal analysis are linear functions, they can be solved analytically by, for example, Gaussian elimination.

As noted previously, the derivatives of the circuit characteristics with respect to the component values are required to enable optimisation to take place. The derivative of the circuit characteristic is calculated using a two step process. Firstly, the circuit characteristic of interest, in this case the maximum voltage gain, is calculated at x₁=x₀+Δx using the DC operating points calculated before, where Δx is a vector with a value Δx in the first position and zeros elsewhere. Secondly, the derivative

$$\frac{ⅆ {v}_{gain}}{ⅆ {x}_{1}} ≅ \frac{{V}_{gain} ( {\underline{x}}_{0} + Δ \underline{x} ) - {V}_{gain} ( {\underline{x}}_{0} )}{Δ x}$$

where V_{gain} (x₀+Δx) is the voltage gain at the point (x₀+Δx), V_{gain} (x₀) is the voltage gain at the point x₀ and Δx is typically 10⁻⁸x₁,

is calculated. For accuracy and continuity, Δx is chosen to be typically 10⁻⁸ x₁. To calculate a value for V_{gain} (x₀+Δx)−V_{gain} (x₀) that is sufficiently accurate to ensure stability of the optimisation problem, the convergence solution needs to be accurate to, for example, 1 part in 10⁹. This means that the DC operating point needs to be calculated very accurately at both x₀ and x₀+Δx. Typically, the solution of the DC operating point, for x₀ and x₀+Δx needs to be calculated to an accuracy of lnV, as noted earlier. Additionally, with such a large required accuracy, any residual inaccuracies may destabilise the optimisation algorithm. As there are, in this case, 18 derivatives to calculate, the solution to the problem may take several hours to complete. This is because the solution for the DC operating point needs to be calculated to an accuracy of lnV. This makes the DC operating point slow to compute due to the very large number of iterations required.

The present invention takes a different approach. In accordance with the described embodiment, the DC operating point is calculated for a given set of component values to an accuracy of typically 0.1 mV. This means that as the component values are changed, the corresponding DC operating point at each of the nodes also changes. Therefore if the set of component values x is changed by a small amount, Δx, then the corresponding DC operating point is altered by a small amount.

If equations (1)-(6) are rewritten as

g(v;x)=0 (7)

and

h(w;x)=0 (8)

where

g≡(g₁,g₂); h≡(h₁,h₂,..,h₄); v≡(V_{bias},Vₛ₄) and w≡(V_{icm},V_{icmp},V_{cas},Vₒᵤₜ)

it may be seen that equations (1)-(6) are dependent upon the component values x. Therefore, for a small change in component value Δx, the values of v and w will be changed by a small amount Δv and Δw respectively. If equations (7) and (8) have therefore been solved for x=x₀ and the solutions for v and w are v₀ and w₀ respectively, then for a small increase in component value, equations (7) and (8) can be written generally as

g(v₀+Δv;x₀+Δx)=0 (9)

h(w₀+Δw;x₀+Δx)=0 (10)

where Δv and Δw are to be determined.

In accordance with a preferred embodiment, the new DC operating point is found for the small change in component value, without the need to resort to the complicated iterative process as noted hereinbefore in relation to the prior art. The new DC operating point is calculated by linearising the local area around the solution of the previously solved DC operating points. Therefore, as the new DC operating point is solved as a solution to a set of linear equations, the precision of the new DC operating point and therefore the derivatives of the DC operating point are found to an accuracy limited only by machine precision, as explained below. Also, the derivatives can be found very quickly.

As an example of linearising the region around the previously solved DC operating point, expanding (9) and (10) using, for example, a first order Taylor expansion will provide

$$\begin{matrix}\underline{g} ( {\underline{v}}_{0} + Δ \underline{v} ; {\underline{x}}_{0} + Δ \underline{x} ) = {( \frac{\partial \underline{g}}{\partial \underline{x}} )}_{( {\underline{v}}_{0} , {\underline{x}}_{0} )} Δ \underline{x} + {( \frac{\partial \underline{g}}{\partial \underline{v}} )}_{( {\underline{v}}_{0} , {\underline{x}}_{0} )} Δ \underline{v} = \underline{0} & ( 11 ) \\ {{( \underline{h} ( {\underline{w}}_{0} + Δ \underline{w} ; {\underline{x}}_{0} + Δ \underline{x} ) = \frac{\partial \underline{h}}{\partial \underline{x}} \vert}_{( {\underline{w}}_{0} , {\underline{x}}_{0} )} Δ \underline{x} + \frac{\partial \underline{h}}{\partial \underline{w}} \vert}_{( {\underline{w}}_{0} , {\underline{x}}_{0} )} Δ \underline{w} = \underline{0} & ( 12 )\end{matrix}$$

The equations g(v₀;x₀)=0 and h(w₀;x₀)=0 are known explicitly from the DC operating points of the circuits previously calculated and the partial derivatives may be also calculated numerically as is known in the art. This is because, at the DC operating point, equations (1)-(6) are known and so the first order partial derivatives shown in equations (11) and (12) can be solved very quickly by finite differencing, as mentioned below.

For example, the linearisation of equations (1) and (2) will result in

$$\{ \begin{matrix}{g}_{1} ( {\underline{v}}_{0} + \underline{Δ v} ; {\underline{x}}_{0} + \underline{Δ x} ) = {g}_{1} ( {\underline{v}}_{0} ; {\underline{x}}_{0} ) + {\sum }_{k} ( \frac{\partial {g}_{1}}{\partial {x}_{k}} Δ {x}_{k} ) + {\sum }_{j} ( \frac{\partial {g}_{1}}{\partial {v}_{j}} Δ {v}_{j} ) ( 13 ) \\ {g}_{2} ( {\underline{v}}_{0} + \underline{Δ v} ; {\underline{x}}_{0} + \underline{Δ x} ) = {g}_{2} ( {\underline{v}}_{0} ; {\underline{x}}_{0} ) + {\sum }_{k} ( \frac{\partial {g}_{2}}{\partial {x}_{k}} Δ {x}_{k} ) + {\sum }_{j} ( \frac{\partial {g}_{2}}{\partial {v}_{j}} Δ {v}_{j} ) ( 14 )\end{matrix} ⇒ \{ \begin{matrix}{g}_{1} ( {\underline{v}}_{0} + \underline{Δ v} ; {\underline{x}}_{0} + \underline{Δ x} ) = {\sum }_{k} ( \frac{\partial {g}_{1}}{\partial {x}_{k}} Δ {x}_{k} ) + {\sum }_{j} ( \frac{\partial {g}_{1}}{\partial {v}_{j}} Δ {v}_{j} ) ( 15 ) \\ {g}_{2} ( {\underline{v}}_{0} + \underline{Δ v} ; {\underline{x}}_{0} + \underline{Δ x} ) = {\sum }_{k} ( \frac{\partial {g}_{2}}{\partial {x}_{k}} Δ {x}_{k} ) + {\sum }_{j} ( \frac{\partial {g}_{2}}{\partial {v}_{j}} Δ {v}_{j} ) ( 16 )\end{matrix}$$

As functions g₁,g₂ are known (see equation (1) and (2)) and Δx is a chosen value, Δv is required. The derivatives of g with respect to x are found by finite differencing, in other words by taking a small value of ∂xₖ and then

$$\frac{\partial {g}_{1}}{\partial {x}_{k}} = \frac{{g}_{1} ( {\underline{v}}_{0} ; {\underline{x}}_{0} + \underline{δ {x}_{k}} ) - {g}_{1} ( {\underline{v}}_{0} ; {\underline{x}}_{0} )}{δ {x}_{k}} \qquad ( 17 )$$

where δxₖ is vector with δxₖ in the kth position and zeros elsewhere. As both Δxₖ and δxₖ are very small, for example 10⁻⁸ times typical values of xₖ, so as to enable good derivative determination by finite differencing, it is reasonable to set them equal to one another. Partial derivatives with respect to v are also calculated by finite differencing, but as Δvⱼ is not known, δvⱼ can not be set equal to Δvⱼ. Therefore, by combining equation (17) into equations (15) and (16) respectively, it can be seen that

$$\{ \begin{matrix}{\sum }_{k} ( {g}_{1} ( {\underline{v}}_{0} ; {\underline{x}}_{0} + \underline{δ {x}_{k}} ) - {g}_{1} ( {\underline{v}}_{0} ; {\underline{x}}_{0} ) ) + {\sum }_{j} ( \frac{{g}_{1} ( {\underline{v}}_{0} + \underline{δ {v}_{j}} ; {\underline{x}}_{0} ) - {g}_{1} ( {\underline{v}}_{0} + \underline{δ {v}_{j}} ; {\underline{x}}_{0} )}{δ {v}_{j}} Δ {v}_{j} ) = 0 \\ {\sum }_{k} ( {g}_{2} ( {\underline{v}}_{0} ; {\underline{x}}_{0} + \underline{δ {x}_{k}} ) - {g}_{2} ( {\underline{v}}_{0} ; {\underline{x}}_{0} ) ) + {\sum }_{j} ( \frac{{g}_{1} ( {\underline{v}}_{0} + \underline{δ {v}_{j}} ; {\underline{x}}_{0} ) - {g}_{1} ( {\underline{v}}_{0} + \underline{δ {v}_{j}} ; {\underline{x}}_{0} )}{δ {v}_{j}} Δ {v}_{j} ) = 0\end{matrix}$$

where δvⱼ is typically 10⁻⁸ times the size of vⱼ.

All the expressions in these equations are now numbers obtained by evaluating equations (1) and (2), except for the two variables, Δv₁, and Δv₂.It is apparent that now there are two linear equations with two variables to be solved. This is solvable, for example, analytically or by another method such as by using Gaussian elimination.

By a similar method, equations (3), (4), (5) and (6) produce four unknown variables with four linear equations which can be solved in a similar manner to that described above. It should be noted that the linear equations above allow the unknown variables to be solved to machine precision so that gradient errors introduced by the necessary imposition of an accuracy threshold (as with the prior art technique) are avoided.

The new DC operating point is therefore found quickly and accurately for a small increase in component value. As a more specific example, equations (1) and (2) can be rewritten as

g₁(v₁+Δv₁;x₁+Δx₁)=I_{bias}−(I_{ds18}(V_{bias}+ΔV_{bias}−(Vₛ₄+ΔVₛ₄), (V_{bias}+ΔV_{bias})−(Vₛ₄+ΔVₛ₄),−(Vₛ₄+Δ(Vₛ₄+ΔV₄))=0 (18)

$${g}_{2} ( {v}_{2} + Δ {v}_{2} ; {x}_{2} + Δ {x}_{2} ) = Ibias - ( \frac{( {V}_{s4} + {dV}_{s4} ) - {AV}_{ss}}{R1} ) = 0 \qquad ( 19 )$$

As V_{bias} and V₄ are known DC operating points, equations (13) and (14) can be combined to calculate ΔVₛ₄ and ΔV_{bias}. A similar method can be used to calculate ΔV_{icm}, ΔV_{icmp}, ΔV_{cas} and ΔVₒᵤₜ as required.

Once the new DC operating point has been calculated, the new circuit characteristic can be calculated and accordingly the partial derivative of the circuit characteristic with respect to each of the components can be calculated by finite differencing.

Additionally, although the above description relates to the optimisation at the device level, it should be noted that higher level circuits, for example, a system level design, may also be optimised using the method described hereinbefore. For a system level design, the design variables described above relate to the sub-circuits of the system. Furthermore, the optimiser will need to know the approximate specifications of each of the sub-circuits and the associated limits of the sub-circuits.

What we claim is:

1. A method of determining a preferred value of at least one electronic system component which optimizes one or more characteristics of an electronic system, the method comprising the steps of:
expressing a steady state condition of the system, at at least one point on the system, in terms of at least one of said system components;
selecting a trial value for the or each system component and calculating said steady state at the or each point;
applying a perturbation to the value of at least one of the said system components of the system, such that a localised region around said steady state condition is linearised; and
determining, as a consequence of said perturbation, a new steady state condition of said electronic system.

2. A method as claimed in claim 1, further comprising the step of:
expressing said given characteristic to be optimised, in terms of said components, wherein the Lagrangian function of said given characteristic is approximated to a quadratic function.

3. A method of determining a preferred value of at least one electronic system component which optimizes one or more characteristics of an electronic system, the method comprising the steps of:
expressing a steady state condition of the system, at at least one point on the system, in terms of at least one of said system components;
selecting a trial value for the or each system component and calculating said steady state at the or each point;
applying a perturbation to the value of at least one of the said system components of the system, such that a localised region around said steady state condition is linearised;
determining, as a consequence of said perturbation, a new steady state condition of said electronic system; and
expressing at least one constraint function that specifies at least one limiting property of said optimised electronic system, with which said system component is to be optimised.

4. A method as claimed in claim 1, wherein said steady state condition is the DC operating point.

5. A method as claimed in claim 1, wherein the linearised first steady state expression is
$${( \frac{\partial \underline{g}}{\partial \underline{x}} )}_{( \underline{{v}_{0}} , \underline{{x}_{0}} )} Δ \underline{x} + {( \frac{\partial \underline{g}}{\partial \underline{v}} )}_{( \underline{{v}_{0}} , \underline{{x}_{0}} )} Δ \underline{v} = \underline{0}$$
wherein: g is a function of said steady state condition; x is said at least one component value; x₀ is said trial component value; v is said steady state condition; and v₀ is said steady state condition at said trial component value.

6. A method as claimed in claim 1, further comprising the step of: expressing at least one constraint function that specifies at least one limiting property of said optimised electronic system component, with which said system component is to be optimised.

7. A method as claimed in claim 3, wherein said at least one constraint function is approximated to a linear function.

8. A method as claimed in claim 3, wherein said the or each electronic system component is optimised in accordance with said at least one constraint function.

9. A method according to claim 1 wherein said steady state condition is calculated using an iterative numerical method.

10. A method according to claim 1 wherein said linearisation of said steady state is in accordance with a first order Taylor expansion.

11. A method according to claim 1 wherein said system components comprise at least one electronic device.

12. A computer readable medium comprising computer program instructions for carrying out the following method steps when executed on a computer:
expressing a steady state condition of the system, at at least one point on the system, in terms of at least one of said system components;
selecting a trial value for the or each system component and calculating said steady state at the or each point;
applying a perturbation to the value of at least one of the said system components of the system, such that a localised region around said steady state condition is linearised; and
determining, as a consequence of said perturbation, a new steady state condition of said electronic system.

13. A computer readable medium as claimed in claim 12, wherein said computer program instructions further comprises the method step of:
expressing said given characteristic to be optimised, in terms of said components, wherein the Lagrangian function of said given characteristic is approximated to a quadratic function.

14. A computer readable medium as claimed in claim 12, wherein said computer program instructions further comprises the method step of:
expressing at least one constraint function that specifies at least one limiting property of said optimised electronic system, with which said system component is to be optimised.

15. A computer readable medium as claimed in claim 12, wherein the linearised first steady state expression is
$${( \frac{\partial \underline{g}}{\partial \underline{x}} )}_{( \underline{{v}_{0}} , \underline{{x}_{0}} )} Δ \underline{x} + {( \frac{\partial \underline{g}}{\partial \underline{v}} )}_{( \underline{{v}_{0}} , \underline{{x}_{0}} )} Δ \underline{v} = \underline{0}$$
wherein: g is a function of said steady state condition; x is said at least one component value; x₀ is said trial component value; v is said steady state condition; and v₀ is said steady state condition at said trial component value.

16. A computer readable medium as claimed in claim 12, wherein said computer program instructions further comprises the step of:
expressing at least one constraint function that specifies at least one limiting property of said optimised electronic system component, with which said system component is to be optimised.
